(19) United States
(12) Patent Application Publication
(10) Pub. No.: US 2010/0293024 A1
(43) Pub. Date: Nov. 18, 2010

(54) Apparatus and Method for Optimizing File Transfer Based Upon Available Bandwidth

(76) Inventors: Xin FENG, Sunnyvale, CA (US); Srinivasa DHARMAJI, Sunnyvale, CA (US)

Correspondence Address: GLENN PATENT GROUP, 3475 EDISON WAY, SUITE L, MENLO PARK, CA, 94025, US

(21) Appl. No.: 12/467,018

(22) Filed: May 15, 2009

(51) Int. Cl. G06Q 30/00; G06Q 10/00

(52) U.S. Cl. 705/8; 705/10; 705/14.49

(57) ABSTRACT

A file transferring method and system (FTMS) optimizes delivery of targeted advertisement files (TAF) to different target groups (TG) that consist of mobile handheld display device (MHDD) users. A server transmits small metadata packets containing a transmission schedule, target group identification (TGID), and information on each TAF, such as file identification, checksum, file size, and number of packets in the file to each MHDD which, on receipt of this metadata, checks the TGID in the metadata packet with a pre-stored TGID in the MHDD. If the TGID received matches the TGID stored in the MHDD, then the MHDD downloads and stores the metadata information. The MHDD then wakes-up during scheduled advertisement (AD) file transmission and downloads the TAFs. The MHDD uses the metadata to verify whether all packets of the TAF have been received without error. In case of error or shortfall, the MHDD wakes-up and downloads missing packets during a next scheduled transmission.

### BACKGROUND OF THE INVENTION

1. Technical Field

The invention relates to the delivery of advertisements to mobile handheld devices. More particularly, the invention relates to an apparatus and method for optimizing file transfer to mobile handheld devices, based upon available bandwidth.

2. Description of the Background Art

Today, mobile handheld display devices (MHDDs), such as cell phones and personal data assistants (PDAs), function as individual content viewing platforms. This shift from group viewing of content to individual viewing provides advertisers with the ability to deliver targeted advertisement files (TAF) and content to focused or targeted groups of individual users of such MHDDs, if capabilities for efficient transmission of such TAFs, and identification of target MHDDs, can be provided. For advertisement (AD) campaigns, targeted AD delivery is more effective than broadcast because it is possible to cater to the individual interests of recipients. This results in better AD campaign results.

However, with increases in the number of target groups and targeted content for each group, the number of TAFs transmitted becomes very large. Typical target groups may be in the hundreds to thousands of individuals for any AD campaign, and the total number of ADs per group can be in the high thousands. The use of MHDDs that include such features as power saving facilities, for example where the MHDD enters a sleep mode when it is not in use, reduces the probability that transmitted AD files are received, and thus increases number of retransmissions of such AD files that are required before the target numbers of AD deliveries in any campaign are reached. This effectively limits the number of target groups for targeted advertisement file (TAF) delivery due to bandwidth constraints. Efforts to find a suitable transmitting system for delivery of focused and targeted ADs and alternate content to a large number of target groups (TGs) within available bandwidth and time constraints are ongoing.

It would be advantageous to have a system and method for TAF delivery that uses transmission time effectively, and that ensures that the MHDDs of all members in a target group are in a wakeup mode during transmission of the TAFs.

It would also be advantageous to be able to split large campaign AD files into multiple packets and download packets meant for the target group, thus improving bandwidth use.

It would further be advantageous to have a mechanism that checks for any errors in a TAF or partial TAF that is received and that selectively downloads any missing portion of the TAF during next transmission.

Addressing these and other problems in connection with the delivery of TAFs would facilitate the transmission of millions of TAFs to thousands of target groups in a bandwidth-limited multicasting environment.

### SUMMARY OF THE INVENTION

An embodiment of the invention relates to the optimal use of available transmission time and bandwidth when delivering focused and targeted advertisement files to a large number of target groups for display on the mobile handheld display devices of target group members in a bandwidth-limited, mobile broadcast system. More particularly, the invention relates to the advance intimation of a transmission schedule for each target group, and the transmission of files as multiple packets to such target groups, to enable the handheld devices of members of the specific target group to wakeup at predefined times and thus download packets transmitted to such handheld devices.

A file transferring method and system (FTMS) is disclosed that optimizes the delivery of a large number of targeted advertisement files (TAF) to mobile handheld display device (MHDD) users in different target groups (TG). A server transmits small metadata packets containing a transmission schedule, target group identification (TGID), and information on each TAF, such as file identification, checksum, file size, and number of packets in the file to each MHDD which, on receipt of this metadata, checks the TGID in a received TAF with a TGID that is pre-stored in the MHDD. If the received TGID matches the TGID stored in the MHDD, then the MHDD downloads and stores the metadata information. The MHDD then wakes-up during a scheduled advertisement (AD) file transmission and downloads the TAFs. The uses the metadata to MHDD verify whether all packets of the TAF have been received without error. In case of an error or shortfall, the MHDD wakes-up and downloads any missing packets during a next scheduled transmission.

### BRIEF DESCRIPTION OF THE DRAWINGS

FIG. 1 is a block diagram showing a file broadcasting system in accordance with the invention;

FIG. 2 is a block diagram of a typical receiver unit having a file reception facility in accordance with the invention;

FIG. 3 is a flowchart that shows the steps performed by a transmitting unit during meta data and scheduled targeted file transmission in a file transferring system implemented in accordance with the invention;

FIG. 4 is a flow chart showing the end of campaign file deletion method disclosed in accordance with the invention; and

FIG. 5 is a flowchart that shows the steps performed by a receiver unit when receiving an information packet through a file transferring system implemented in accordance with the invention.

### DETAILED DESCRIPTION OF THE INVENTION

An embodiment of the invention relates to the optimal use of available transmission time and bandwidth when delivering focused and targeted advertisement files to a large number of target groups for display on the mobile handheld display devices of target group members in a bandwidth-limited, mobile broadcast system. More particularly, the invention relates to the advance intimation of a transmission schedule for each target group, and the transmission of files as multiple packets to such target groups, to enable the handheld devices of members of the specific target group to wakeup at predefined times and thus download packets transmitted to such handheld devices.

A file transferring method and system (FTMS) is disclosed that optimizes the delivery of a large number of targeted advertisement files (TAF) to mobile handheld display device (MHDD) users in different target groups (TG). A server transmits small metadata packets containing a transmission schedule, target group identification (TGID), and information on each TAF, such as file identification, checksum, file size, and number of packets in the file to each MHDD which, on receipt of this metadata, checks the TGID in a received TAF with a TGID that is pre-stored in the MHDD. If the received TGID matches the TGID stored in the MHDD, then the MHDD downloads and stores the metadata information. The MHDD then wakes-up during a scheduled advertisement (AD) file transmission and downloads the TAFs. The MHDD uses the metadata to verify whether all packets of the TAF have been received without error. In case of an error or shortfall, the MHDD wakes-up and downloads any missing packets during a next scheduled transmission.

In an embodiment, TAFs are delivered to a large number of TGs via wireless broadcasting. The file transferring system overcomes bandwidth limitations inherent in mobile transmissions, where target group members number into the thousands and the total number of TAFs for delivery run into the millions. An error checking mechanism is included that reloads missing or corrupt packets during a next transmission. There is also a provision for campaign management and control via metadata that is used for file control to intimate various MHDDs of a TG that is associated with an AD campaign to delete stored files at the end of a campaign, thus optimizing the use of storage resources in such handheld devices.

A TGID is input into each MHDD during an initial configuration of the MHDDs of each member in each TG. This TGID uniquely identifies the MHDD as belonging to a specific TG or to a number of TGs. The formation of TGs is disclosed in a U.S. patent application entitled Method for Grouping, Targeting, and Meeting Objectives for an Advertisement Campaign, Ser. No. 12/191,086, filed Aug. 13, 2008, which claims priority from U.S. provisional patent application Ser. No. 60/935,520, filed 16 Aug. 2007, and which is incorporated herein in its entirety by this reference thereto.

A campaign manager and control mechanism, that is part of the FTMS, generates metadata for each TAF, TG, and a campaign transmission schedule. The metadata define targeted user group members to whom an AD file is to be downloaded during transmission, as well as a scheduled download time. The FTMS intimates all group members on a campaign transmission schedule by frequently transmitting a small packet to them that contains the metadata. The metadata packet is small in size, typically of the order of a few bytes, and therefore does not require much bandwidth to transmit. Once received and decoded, the metadata causes the hand held devices all members of a user group that are in a sleep mode or similar power/battery saving mode to wakeup and download the TAF during its transmission. This reduces the retransmission rate and allows better use of transmission time, thus making the addressing of a larger number of user groups and TAFs possible.

Files are sent in the form of multiple packets, with a header containing details of packet structure, file size, packet number, checksum, etc., as well as information that helps the handheld device check for any missing packet or reception error. In the event a packet is determined to be missing, the handheld device can download those specific packets and skip other packets, thereby reducing file download overhead during the next TAF transmission. The transmission schedule intimation and packet transmission scheme help the handheld device in downloading specific TAFs efficiently, thus improving the reception process efficiency, reducing the number of retransmissions, and ensuring better bandwidth use. The campaign manager and control mechanism can also intimate the end of a campaign to the MHDD. In one implementation, this is done by sending a packet with a TAF identifier with negative sign to all user groups in the campaign. The handheld device, on receipt of this message, deletes the stored TAF from its local memory, thus improving storage space use.

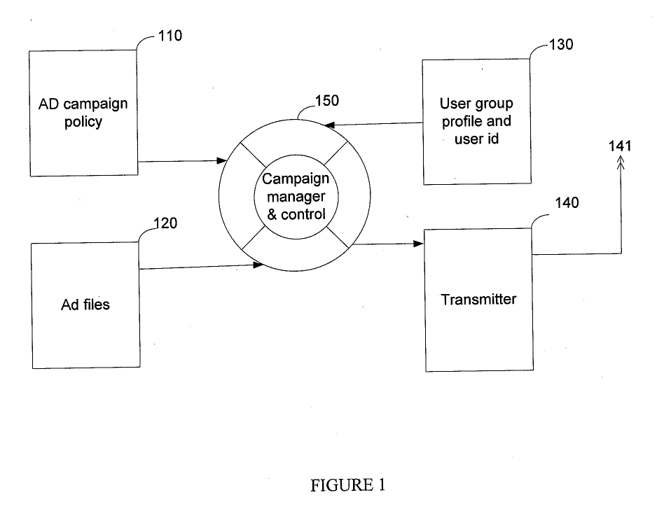

FIG. 1 is a schematic block diagram of a file transmitting system 100 according to an embodiment of the invention. The transmitter 140 sends advertisement campaign files to each of the MHDDs in the TG as packets at predefined times via the antenna 141. An AD campaign policy 110 is set to the MHDDs by the campaign. The campaign manager and control mechanism 150 defines the TGs of the MHDDs, based upon the campaign policy 110, as well as available user group information 130 for the campaign. The campaign manager and control mechanism 150 also defines the duration of the campaign. Based on these decisions, the campaign manager and control mechanism 150 decides on which TAFs are to be chosen from the available advertisements 120, and then generates a TAF transmission schedule. The schedule includes a transmission repetition frequency and a time schedule that is based upon set algorithms which include file size, number of users in the group, retransmission requests, and transmission error history. The transmission schedule, TGIDs, and TAF identification each form part of a metadata file that is transmitted to each of the MHDDs in the TG on a regular basis. The campaign manager and control mechanism 150 then prepares compatible packets of the TAFs with an associated metadata header that contains packet details, including packet identification, TGID, number of packets in the TAF, check sum, etc. The transmitter 140 broadcasts these packets over a multicast channel at a scheduled time that was previously transmitted to the MHDDs as metadata. The metadata that are received with regular transmissions enable the MHDDs to wake up and download TAF packets that correspond to the TGID of the MHDD.

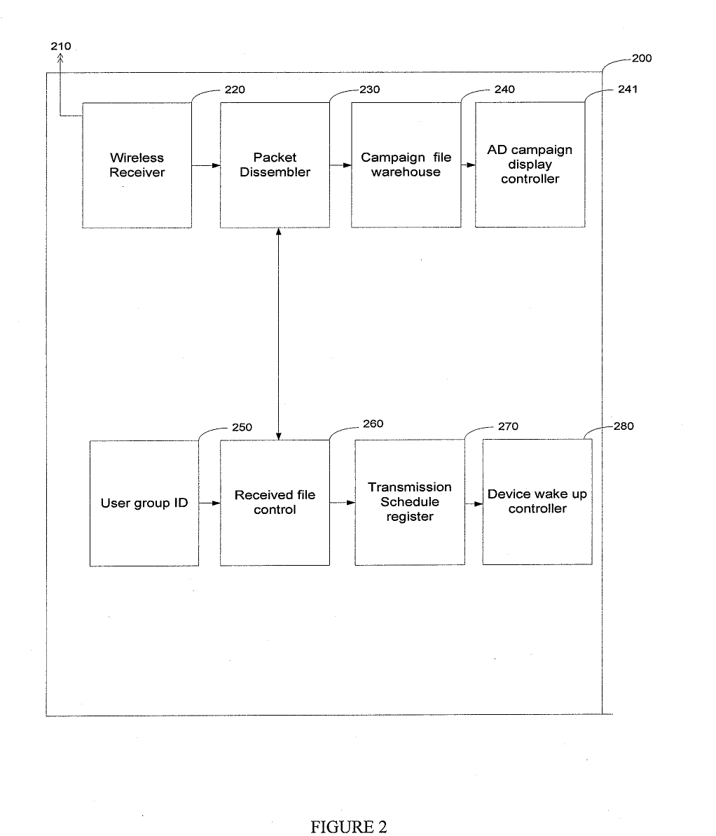

An ad campaign policy 110 defines the life of the campaign. At the end of a campaign, the FTMS campaign manager and control mechanism 150 generates a TAF deletion command with corresponding TGIDs and broadcasts it as metadata to the appropriate MHDDs to indicate that the campaign has ended. This allows the TAFs stored in the MHDD for a specific campaign to be deleted from the memory of the MHDD. The MHDDs then release this space in their memory, typically the campaign file warehouse 240 (FIG. 2), to make it available for the storage of the next set of TAFs that is scheduled for the next designated campaign. The end of campaign status data, once received, generates a file drop command which is routed to the campaign file warehouse 240. The file drop command deletes the TAF relating to the specific campaign stored in the campaign file warehouse 240. A typical delete file command is provided in the form of a negative sign in the metadata that are transmitted to the MHDDs on a regular basis, thus indicating the end of a campaign. Other forms of end of campaign notification are readily provided, as selected by those skilled in the art.

FIG. 2 is a block diagram of a file receiving system in the MHDD according to an embodiment of the invention. The wireless receiver 220 receives all packets when the MHDD is awake and transfers them to the packet disassembler 230. The packet disassembler receives the metadata AD campaign schedule as a packet and verifies a packet header with a control data mechanism 260 that includes a target group ID number 250. In the event the target group ID number in a packet matches the TGID stored in the MHDD, the transmission schedule details are stored in a campaign schedule register 270. The transmission schedule details are stored in the register 270 until a full file download success status indicator is provided by the packet disassembler 230.

The campaign schedule register 270 issues a device wakeup command to the MHDD power-on controller 280 at a transmission time that is specified in the stored schedule detail, which itself is stored in the campaign schedule register 270. This command is issued at all scheduled times until a full file download status indication is obtained, with the correct packet count, and without error at the end of the file. Once it receives full AD files without error, the packet disassembler registers the AD file in the campaign file warehouse 240 and marks the download status as fully downloaded. The packet disassembler then stops any further awakening the MHDD on the scheduled transmission time to check for the specific AD files.

The packet disassembler 230 extracts identify of the information from all received metadata and packets, including information in such categories as transmission schedule data, AD file data, and end of campaign data. If the information is metadata, then it is processed to identify if the information has the TGID of the MHDD. If the TGID matches, then the information contained in the packets was sent to the MHDD to be used by the MHDD. If the information comprises AD file packets, then the packet disassembler 230 extracts campaign AD files from the multiple packets, checks for the AD files for integrity, and registers missing or erroneous packets, if any. The packet disassembler fetches any missing packet in the next transmission.

A method of achieving forward error correction for error free reception of files received in multiple transmissions is disclosed in the co-pending provisional patent application No. 61/189,106, filed on 15 Aug. 2008, entitled Maximizing Wireless Bandwidth During Ad Transmission with Forward Error Correction (FEC), which application is incorporated herein in its entirety by this reference thereto.

Once all packets are checked and found to be error free through comparison of the checksum, the packet disassembler 230 enables the end of file by closing the AD file. The packet disassembler then releases file download success status to the received file control register 260. This status receipt at the received file control register 260 resets the transmission schedule in the transmission schedule register 270 as completed for the particular campaign number. A complete TAF for the campaign file is then stored in campaign file warehouse 240 and spooled to the display device 241, based on the defined AD insertion policy.

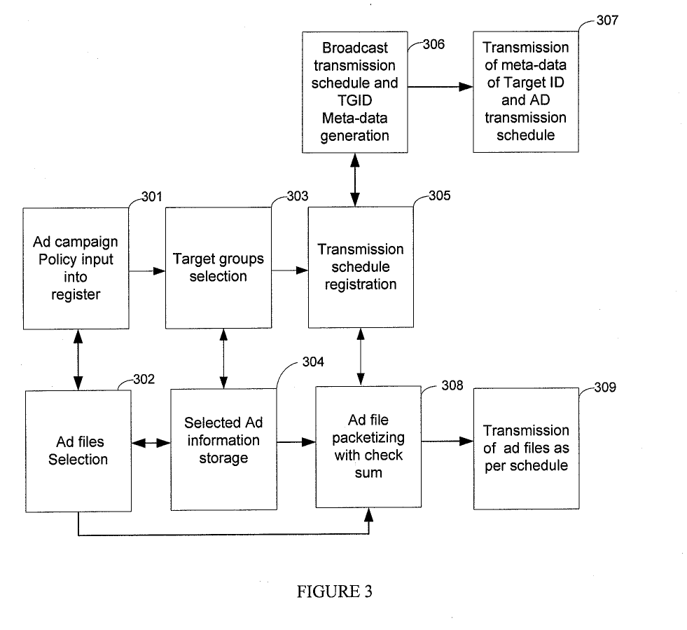

FIG. 3 is a flow diagram showing transmission using the transmitter portion of the FTMS. A first step registers the AD campaign policy information 101 in a policy register (S301). The campaign manager and control mechanism uses the campaign policy information 101 from the campaign policy register 301 to select the AD files necessary for the campaign (S302). These files are selected for use with a set of selected TGs that form the focus of the campaign. The campaign manager and control mechanism then registers the TGID numbers of the identified TGs in a target group register (S303). The TAF information for each TGID group is defined and stored in an AD information register (S304). Based on target TAF file size and available free time, the campaign manager and control mechanism generates a transmission schedule and registers it in the transmission schedule register (S305). This information is converted to metadata for all TGs and TAFs chosen (S306). The system broadcasts this metadata packet at intervals that are set by the metadata transmission schedule (S307). The TAFs are converted to system compatible packets the include a packet identification and a check sum, and are registered in the AD file packet and check sum register (S308). The AD packets are broadcast at a scheduled time, as specified in the metadata (S309), for reception by the respective MHDDs of each TG.

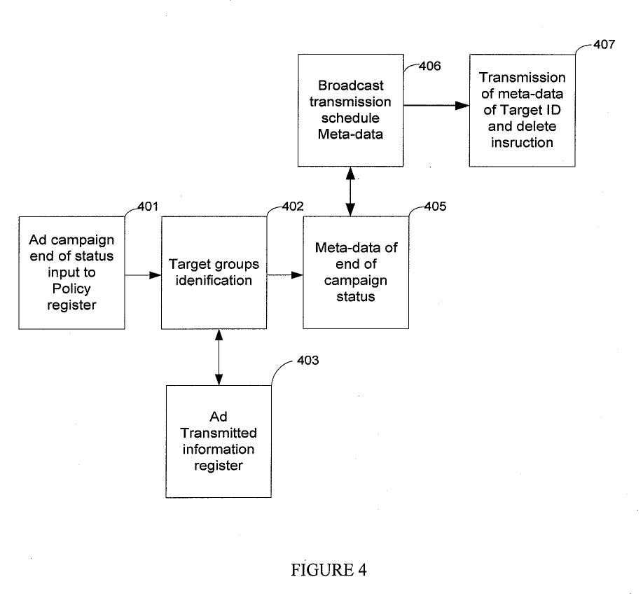

FIG. 4 is a flow diagram showing an end of campaign process for transmission of a deletion of files instruction. At the end of a campaign, the campaign manager and control mechanism generates an end of campaign status as a policy. The end of campaign status is input into the campaign policy register (S 401). This information is used by the target group register to identify the specific TGs of that campaign (S 402). The AD file information register uses the information provided by the target group register to identify the TAFs transmitted as part of the campaign (S 403). For each TAF transmitted and stored in the target MHDDs, a metadata instruction with a TGID and a file deletion instruction is generated (S 405). The end of campaign information is transmitted with the scheduled metadata by the transmitter (S 406) to selected TGID groups in accordance with the metadata broadcast schedule (S 407).

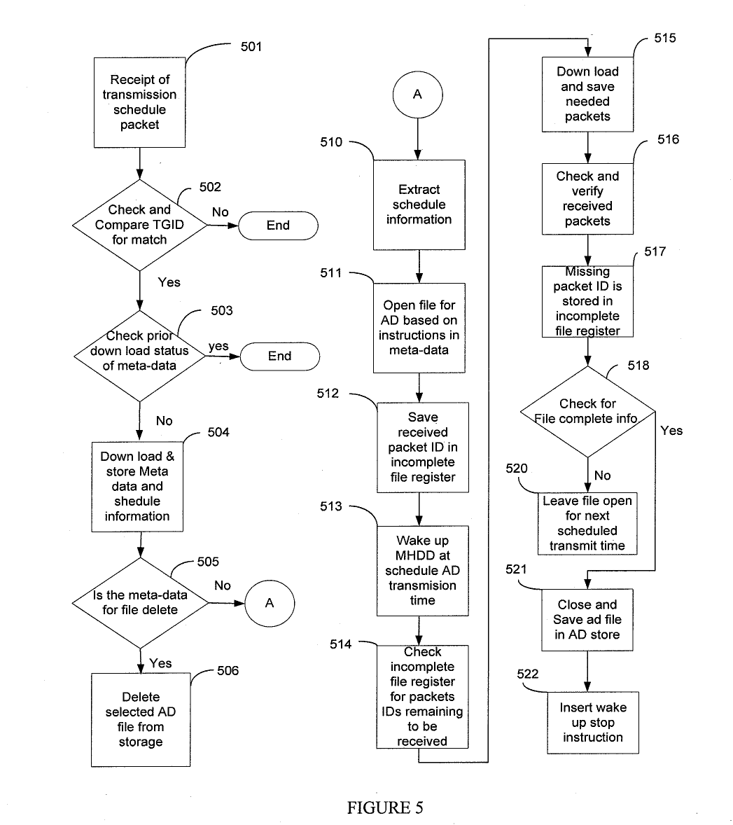

FIG. 5 is a flow diagram showing AD file reception and storage by an FTMS compatible receiver on the MHDD. The MHDD receives transmission schedule metadata packets whenever the MHDD is in wakeup mode (S 501). The MHDD checks the TGID in the metadata packet (S 502). If the received TGID matches the TGID stored in the MHDD, then the metadata download status is also checked for prior receipt of the metadata (S 503). If metadata was not received previously, the metadata information is downloaded and stored (S 504). The metadata is tested to determine if it includes a file delete instruction (S 505). If such instruction is included in the metadata, then the instruction is used to delete the specified file from the AD file store (S 506). If the metadata received is new, it is downloaded and processed to extract the schedule and file information therefrom (S 510). A new AD file is opened using the file information (S 511). The packet IDs are stored in an incomplete file register (S 512). Based on the information received, the transmission schedule register issues a device wakeup command at the scheduled transmission time (S 413). In wakeup mode, the MHDD downloads AD files during scheduled transmission time. The AD file, or balance of the packets of the AD file, is downloaded, based on the stored information in the incomplete file register (S 514). When AD packets still needed to complete the AD file are downloaded (S 515), the downloaded packet numbers are verified for correctness and completeness, and then saved (S 516). The missing packet information is stored in the incomplete file register (S 517). The stored file is checked for completeness (S 518). If all packets have not been correctly received, the file is kept open for the next scheduled AD transmission (S 520). Only the packets specified in the partial download file register are downloaded at each reception.

If the packets have all been received and verified (S 518), the packets downloaded are verified for packet errors, the file is closed, and it is stored in the AD store on the MHDD (S 521). A no wake-up instruction is issued to change the status of the system update file download status of the AD file contained in the schedule register (S 522). This prevents the MHDD from being awakened for the completed file. The AD files stored in file AD file memory is used during the campaign.

The use of the sequence with the forward error correction in the received site reduces the number of times the AD has to be repeated to have the required percentage of the MHDDs in any target group store any specific AD. This reduces the bandwidth usage when large numbers of target groups with large number of ads for each target group are involved.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for transferring targeted advertisements to mobile devices, comprising the computer implemented steps of:
identifying at least one target group comprising at least one user having a mobile handheld device;
generating a targeted advertisement file transmission schedule for said target group;
transmitting said targeted advertisement file as metadata to all mobile handheld display devices in said target group; and
using said targeted advertisement file transmission schedule to wake up said mobile handheld display devices from a power saving sleep mode at a time scheduled for transmission of a targeted advertisement.

2. The file transfer method of claim 1, wherein an end of campaign intimation is provided to said target group as metadata, said metadata comprising an intimation to delete any targeted advertisement file stored in said mobile handheld display devices within said target group.

3. The method of claim 1, said transmitting step comprising the steps of:
identifying a target group that matches a target group identification for an advertisement campaign;
selecting a set of target advertisement files from a group of available advertisements for use in said advertisement campaign;
generating a set of packets for transmission from said targeted advertisement file;
generating packet identification information and verification information for each said packet of said targeted advertisement file;
generating a targeted advertisement file transmission schedule for said packets of said targeted advertisement file;
generating metadata comprising said target group identification, said packet identification information, and said targeted advertisement file transmission schedule;
transmitting said metadata to said target group at regular intervals; and
transmitting said targeted advertisement file to said target group in accordance with said targeted advertisement file transmission schedule;
wherein a targeted mobile handheld display device is awakened from a power saving sleep mode based on said targeted advertisement file transmission schedule;
wherein said targeted advertisement file is downloaded based on said targeted advertisement file transmission schedule; and
wherein bandwidth use is improved by reducing retransmission requirements when delivering a plurality of targeted advertisement files to a plurality of target group members.

4. The method of claim 3, further comprising the step of:
scheduling a transmission time for said targeted advertisement file for said target group to optimize available transmission time usage;
wherein a number of target groups that can be covered for each advertisement campaign is increased.

5. The method of claim 1, further comprising the step of;
converting each targeted advertisement file to multiple packets that contain metadata, said metadata comprising any of file size, packet size, checksum, and an end of file indication.

6. The method of claim 1, further comprising the steps of:
receiving said targeted advertisement file at each said mobile handheld display device, said receiving step comprising the steps of:
receiving metadata comprising a target group identification, a set of packet identifications for a target advertisement file, verification information for said packets, and said targeted advertisement file transmission schedule;
comparing said target group identification with a target group identification stored on said mobile handheld display device;
accepting and storing said metadata on said mobile handheld device if said target group identification for said mobile handheld device matches said target group identification received in said metadata;
extracting and storing said transmission schedule for said targeted advertisement file;
waking up said mobile handheld display device at a scheduled time of transmission to download said targeted advertisement file;
using said verification information to check said downloaded targeted advertisement file for completeness; and
waking up said mobile handheld display device at subsequent scheduled times of transmission to continue downloading said targeted advertisement file until said targeted advertisement file is complete

7. The method of claim 6, further comprising the step of:
verifying said received targeted advertisement file packets for correctness and completeness, based on information contained in said metadata, prior to said mobile handheld display device closing said targeted advertisement file.

8. An apparatus for transmitting targeted advertisement files to mobile hand held devices, comprising:
a campaign manager and control mechanism adapted for packetizing said targeted advertisement files for transmission, generating a transmission schedule for said targeted advertisement files, and generating metadata with regard to targeted advertisements, said metadata comprising a target identification, a target file transmission schedule, a number of packets per said target advertisement file, and a check sum; an ad campaign policy register, in communication with said campaign manager and control mechanism, adapted for defining ad campaign policies for target groups, targeted advertisement file types, and duration of an advertising campaign;
an ad file register, in communication with said campaign manager and control mechanism, adapted for storing a plurality of advertisement files from which said targeted advertisement files are selected for use in said advertising campaign; and
a transmitter, in communication with said campaign manager and control mechanism, adapted for transmitting said metadata to targeted mobile hand held display devices at regular intervals, and for transmitting said target advertisement files to said target mobile handheld display devices in accordance with a transmission schedule.

9. An apparatus for receiving targeted advertisement files and schedule metadata, comprising:
a wireless receiver, said wireless receiver comprising;
a packet disassembler adapted for separating said schedule metadata from any attached file control data;
a user group ID register adapted for pre-storing a target group identification of a user of said wireless receiver;
a file control register adapted for matching a received target group identification against a target group identification stored in said wireless receiver in connection with acceptance of said targeted advertisement files and schedule metadata;
a transmission schedule register adapted for storing received metadata comprising a targeted advertisement file transmission schedule;
a device wake up controller adapted for waking up a mobile handheld display device associated with said receiver at a time specified in said file transmission schedule;
a campaign warehouse register adapted for storing a received and accepted targeted advertisement file; and
an ad campaign display controller adapted for rendering and displaying said received targeted advertisement file during a specified ad-spot in a received content stream;
wherein said mobile handheld display device is awakened at the scheduled transmission time of the targeted advertisement file to permit reception of the targeted advertisement file at that time.
